(19) United States
(12) Patent Application Publication
(10) Pub. No.: US 2004/0192343 A1
(43) Pub. Date: Sep. 30, 2004

(54) System and method for location annotation employing time synchronization

(76) Inventor: Kentaro Toyama, Redmond, WA (US)

Correspondence Address: Katrina A. Lyon, LYON & HARR, LLP, Suite 800, 300 Esplanade Drive, Oxnard, CA, 93036, US

(21) Appl. No.: 10/353,314

(22) Filed: Jan. 28, 2003

(51) Int. Cl. H04M 3/42

(52) U.S. Cl. 455/456.1; 455/414.1

(57) ABSTRACT

A system and method for identifying and/or annotating location for a desired event. This location annotation system and method presumes the existence of two components. The first is a location history (a record of a person, object, or other entity's location history, with locations of the person, object or entity time-stamped so that the record contains location information for a particular time or times). The second component is a set of one or more documents which are time-stamped. The time-stamp is typically meaningfully related to a critical event in the lifetime of the document (e.g., creation time, modification time, and so forth). A document can be any electronic entity, regardless of its permanence or the means by which it is stored. Given the two discussed components, the location annotation system and method consists of a variety of methods for processing the time stamps of the document(s) to be annotated with the location history such that documents can be associated with the location at which critical events, or other events of interest, in the document lifetime took place.

### BACKGROUND

1. Technical Field

This invention is directed toward a system and method for annotating electronic documents with location data. More specifically, this invention is directed towards a system and method for processing time stamps of documents with the location history from other location-aware sources such that the documents can be associated with the location at which critical events in the document's lifetime took place.

2. Background Art

Mobile computers and communication devices are establishing themselves as common place in everyday life. This development is linked to substantial growth in the number and sophistication of mobile and mobile-aware devices and software applications. Increasingly, such devices and applications need access to information about their own and other objects' physical locations, a requirement known as location-awareness.

As electronic location-awareness technologies proliferate (e.g., 911 cell phones, GPS units, wireless networks, etc.), a range of scenarios envision making use of this information for tasks such as delivering location-specific advice to users. For example, a user may want to know where a particular photograph was taken, or where a given document was created. Location information can be used to answer these questions.

### SUMMARY

The present invention is directed toward a location annotation system and method that stamps or otherwise associates electronic documents or files with location information. This location information may be attached to the file permanently (e.g., via metadata) or may simply be calculated, but not saved, each time this location information is sought.

The location annotation system and method presumes the existence of two components: (1) a record of a person, object, or other entity's location history, with locations time-stamped so that the record contains information that pairs instances of time with particular locations, where the location may be specified by any type of encoding of physical location, such as a latitude/longitude coordinate, a place name, a street address, etc., or any piece of information that could be associated with a physical location, such as the IP address of a computing device on the Internet. This record is referred to as a location history; and (2) a set of documents that are time-stamped, with the time-stamp typically being meaningfully related to a critical event in the lifetime of the document (e.g., creation time, modification time, and so forth). This document set, to which location information is to be associated, is referred to as the target document set, or target set for short. A single document in the target set is called a target document. A document is any electronic entity, regardless of its permanence or the means by which it is stored. That is, files are documents; portions of files can be documents; database entries can be documents; temporary data structures that may never be saved to disk can be documents.

Given these components, the location annotation system and method consists of a variety of methods for processing the time stamps of the target set with a location history such that target documents can be associated with the location at which critical events in the document lifetime took place. These location stamps can be cached after being computed. For example, they could be embedded in the metadata of the documents themselves. Or, they may simply be made visible to a user without caching. That is, the association may be performed by either computing it once and storing it, or it may be computed spontaneously each time the information is requested. This association mechanism is termed the location-association module.

In one “nearest neighbor” embodiment of the location annotation system and method, the location-association module does the following: For a given target document for which there exists a time-stamp associated with an event (e.g., document creation date, document modification date, document e-mailed date, etc.), the module looks up the location history for the object, person, or entity most closely associated with the event in question, and associates the location record in the history whose time stamp (after time normalization) is closest to the time-stamp of the document event or event of interest.

Another “nearest earlier neighbor” embodiment functions in a manner similar to the Nearest Neighbor embodiment discussed above. However, this embodiment differs in that it is constrained further to return the location associated with a time that is before or equal to the time-stamp of the document.

The “nearest later neighbor” embodiment of the location annotation system and method also operates in a manner similar to the Nearest Neighbor embodiment except that the constraint is for the location associated with a time that is equal to or after the time-stamp of the document.

In the “interpolated location” embodiment of the location annotation system and method, the system interpolates location if the exact desired time of an event is not available. One of the simplest methods of interpolation that can be used is linear interpolation. Other interpolation schemes include, but are not restricted to, the use of splines or other curves.

In the “model interpolated location” embodiment of the invention models are employed to interpolate location at a given time. Instead of blindly interpolating the location among the temporal neighbors of the data as above, the Model-Interpolated Location embodiment uses “semantic” or generative or other models of the data. These models may be generative models, rule-based models, probabilistic/statistical models, calendar-based models, frequency-based models or any other model that encodes the location history and location patterns of the modeled entity.

The “extrapolated location” embodiment uses extrapolation to specify a location that is out of the range of a location history. It is possible, by using extrapolation instead of interpolation, to generate location associations for instances that are outside the range of a location history. These can apply to moments in the past prior to when the first location-history datum is available; or, they can apply to the future. These techniques are straightforward extensions of the interpolation methods described above.

If multiple location histories are available, standard techniques for fusing data can be used in combination with any of the techniques above to result in more accurate location associations. Data fusing techniques can be based on, but are not limited to, probabilistic fusion, explicit procedural fusion through if-then statements, fusion by voting, averaging, weighted averaging, median computation, and so forth.

The core location-association module can be enhanced by a variety of augmentations. For example, a variety of time-stamp adjustments can improve the accuracy of location association. In some embodiments employing multiple data sources, time stamps are offset to synchronize the time stamps from the various sources to a common reference time. This is done by keeping track of the offsets between time-stamping devices such as cameras, PDAs, laptops, GPS, cellular phones, and so forth, with a single computer's clock. The time-stamps produced by these devices can then be offset accordingly, particularly with respect to location histories and target documents, so that all relevant time-stamps are synchronized to the same clock. If there is a priori information that certain target documents tend to be created at certain times or certain locations, this information can be used to synchronize time stamps in the absence of offset synchronization. A more sophisticated means to accomplish this uses statistical methods to determine the optimal offset.

Additional information about the location associations themselves may be computed and used to affect the location association output.

### DESCRIPTION OF THE DRAWINGS

The specific features, aspects, and advantages of the present invention will become better understood with regard to the following description, appended claims, and accompanying drawings where:

FIG. 1 is a diagram depicting a general purpose computing device constituting an exemplary system for implementing the invention.

FIG. 2 is a general flow diagram depicting the Nearest Neighbor embodiment of the location annotation system and method according to the invention.

FIG. 3 is a general flow diagram depicting the Nearest Earliest Neighbor embodiment of the location annotation system and method according to the invention.

FIG. 4 is a general flow diagram depicting the Nearest Later Neighbor embodiment of the location annotation system and method according to the invention.

FIG. 5 is a general flow diagram depicting the Interpolated Location embodiment of the location annotation system and method according to the invention.

FIG. 6 is a general flow diagram depicting the Model-Interpolated Location embodiment of the location annotation system and method according to the invention.

FIG. 7 is a general flow diagram depicting the Extrapolated Location embodiment of the location annotation system and method according to the invention.

### DETAILED DESCRIPTION OF THE PREFERRED EMBODIMENTS

In the following description of the preferred embodiments of the present invention, reference is made to the accompanying drawings which form a part hereof, and in which is shown by way of illustration specific embodiments in which the invention may be practiced. It is understood that other embodiments may be utilized and structural changes may be made without departing from the scope of the present invention.

1.0 Exemplary Operating Environment

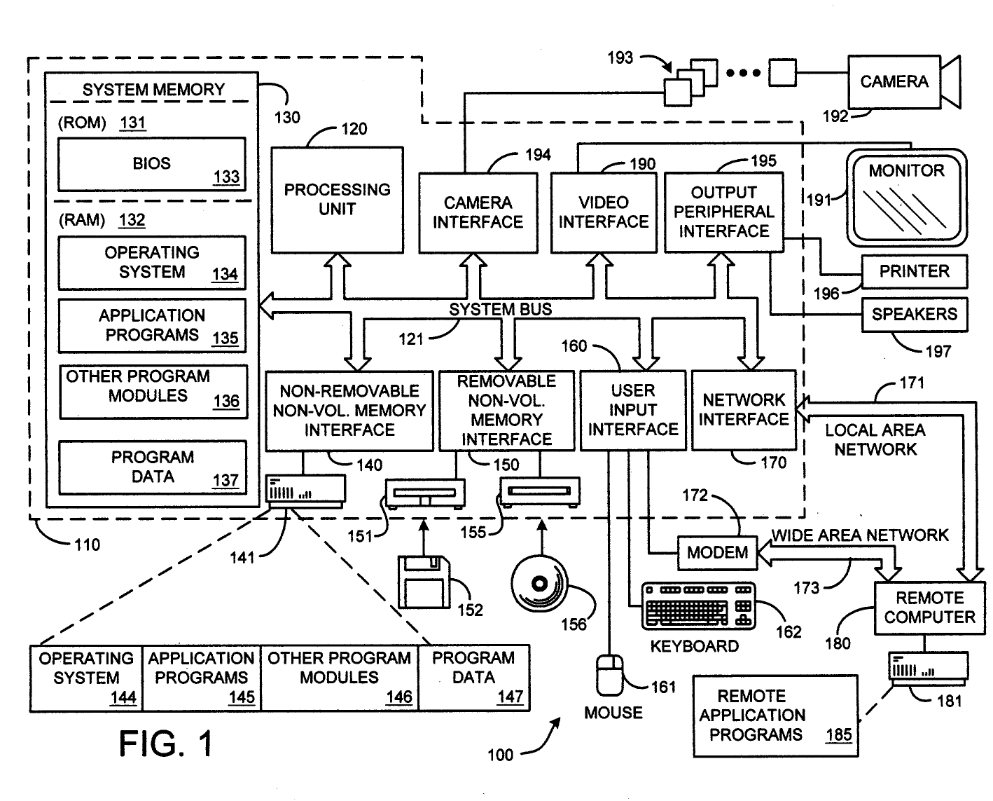

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through anon-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus 121, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195. Of particular significance to the present invention, a camera 163 (such as a digital/electronic still or video camera, or film/photographic scanner) capable of capturing a sequence of images 164 can also be included as an input device to the personal computer 110. Further, while just one camera is depicted, multiple cameras could be included as an input device to the personal computer 110. The images 164 from the one or more cameras are input into the computer 110 via an appropriate camera interface 165. This interface 165 is connected to the system bus 121, thereby allowing the images to be routed to and stored in the RAM 132, or one of the other data storage devices associated with the computer 110. However, it is noted that image data can be input into the computer 110 from any of the aforementioned computer-readable media as well, without requiring the use of the camera 163.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

The exemplary operating environment having now been discussed, the remaining parts of this description section will be devoted to a description of the program modules embodying the invention.

2.0 Location Annotation System and Method

In the following paragraphs the system and method of annotating location information using time synchronization is described in more detail.

2.1 General Overview.

This location annotation system and method according to the invention presumes the existence of two components. The first of these components is a record of a person, object, or other entity's location history, with locations of the person, object or entity time-stamped so that the record contains location information for a particular time or times, pairing instances of time with particular locations, where the location may be specified by any type of encoding of physical location, such as a latitude/longitude coordinate, a place name, a street address, etc., or any piece of information that could be associated with a physical location, such as the IP address of a computing device on the Internet. This record is termed as a location history. The second component is a set of one or more documents which are time-stamped and for which location information is sought. The time-stamp is typically meaningfully related to a critical event in the lifetime of the document (e.g., creation time, modification time, and so forth). The document or documents are referred to as the target document set, or target set for short. A single document in the target set is called a target document. A document can be any electronic entity, regardless of its permanence or the means by which it is stored. That is, files are documents; portions of files can be documents; database entries can be documents; and temporary data structures that may never be saved to disk can be documents. These documents can be photographs or other image files, text documents, presentations, music files, or videos, to name a few.

Given these components, the location annotation system and method according to the invention consists of a variety of methods for processing the time stamps of the target set with the location history such that target documents can be associated with the location at which critical events, or other events of interest, in the document lifetime took place. For example, assume a collection of photos were taken near the Emperor's Palace in Tokyo around 5:30 pm, Dec. 8, 2001 with a digital camera which has no location-awareness technology in and of itself. These photos would be time-stamped by their creation date, but they would contain no location metadata. Fortunately, the photographer in this scenario regularly carries a mobile phone, of the kind which is aware of its location to some accuracy. He further has a service set up which polls the location of his cell phone and records them, together with the polling time, on a home PC at periodic intervals. When he returns home, as he uploads his photos to the PC, the location stamping module applies location stamps to his photographs, so that he can tell approximately where each photo was taken. These location stamps can be cached after being computed. For example, they could be embedded in the metadata of the digital photo documents themselves. Or, they may simply be made visible to the user without caching, so that the user can tell where the photo was taken. That is, the association may be performed by either computing it once and storing it, or it may be computed in real time each time the information is requested. This association mechanism is termed the location-association module.

2.2 Description of the Inputs

There are few established standards for a location-history format, or even a description for what kind of information a location history would contain. The location annotation system and method according to the invention thus employs a range of the possible location histories and their sources. However, the location annotation system and method is not limited to handling only these types of location histories, but can be adapted to work with any type of location history.

Effectively, any description of the location of an object, person, or other entity, together with the time at which the location was recorded, forms a location history. Examples include, but are not limited to the following:

A list of Global Positioning System (GPS) coordinates, together with time stamps. GPS devices, for example, often maintain a log of where and when the unit has been, any time it is on. This log is a location history.

A list or data base of place names, together with time stamps or intervals. For example, a person's digital calendar typically has a record of events, with the expected location and durations of the events. The collection of these calendar events forms a location history.

A portable computing device (e.g., laptop, PDA, handheld, etc.) may know which wireless hub it is communicating with at any moment. If the computing device records this information every minute, and if there is a way to map a wireless hub with its location, then this record forms a location history.

A cellular telephone may be able to triangulate its position based on the strength of the signal from nearby cell towers. If the telephone records this information, with time stamp, this forms a location history.

A collection of time-stamped documents which are themselves location-stamped. The set of all of the correlated time and location information of this document or documents forms a location history.

A miscellaneous collection of all of the various location histories above if they pertain to the same object, person, or entity, would together form a location history.

It should be noted in the above that there are parameters which differ depending on the way the information is collected: the frequency and regularity at which location information is available; the accuracy and precision of both the time and location information; the way location is represented (e.g., as a place name, as GPS coordinates, by proximity to cell towers, etc.); the way time is represented (e.g., relative to GMT, in milliseconds since Jan. 1, 1970, etc.); the source of the information; and so forth. The location annotation system and method of the invention is indifferent to how these parameters are stored, as long as the semantic information about time and location are available. Any type of location history can be a valid input to the location-association module. Similarly, any type of target set is allowable, provided that elements in the target set are associated with time stamps, themselves of arbitrary representation, precision, and accuracy.

Finally, it is assumed that there is a way to convert all of the time information in both the location history and the target set into a single representation, which is termed time normalization. In one embodiment of the invention, time is represented as the number of seconds since the midnight preceding Jan. 1, 1900 GMT, in floating point. Note, however, that this is for the purposes of example, only, and that the invention is by no means restricted to using this representation. Any representation of time will do as long as it is consistent within the location-association module.

2.5 Description of Various Embodiments and Implementations

2.5.1 Nearest Neighbor Embodiment: In the Nearest Neighbor embodiment of the location annotation system and method, for a given target document for which there exists a time-stamped associated with an event (e.g., document creation date, document modification date, document e-mailed date, etc.), the location-association module looks up the location history for the object, person, or entity most closely associated with the event in question, and associates the location record in the history whose time stamp (after time normalization) is closest to the time-stamp of the document event. For example, consider a digital photograph, which contains a creation date/time representing 1:59 pm GMT, Dec. 27, 2001 and a location history of the photographer, consisting of GPS coordinates of his whereabouts every hour on the hour for all of 2001. This embodiment of the location-association module would associate the photograph's creation event with the photographer's GPS coordinates at 2 pm GMT, Dec. 27, 2001. This information could be written back into the photograph's metadata (e.g., as Exchangeable Image File Format (EXIF tags)), it could be stored on a separate database, in a table that indexes the photograph, or it could be computed on request and never stored explicitly.

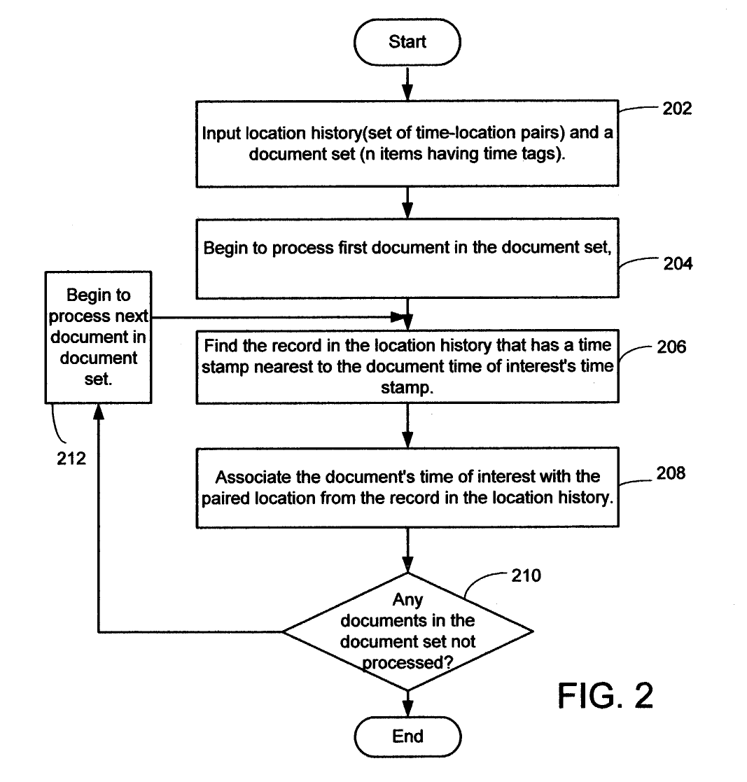

A general flowchart of the Nearest Neighbor embodiment of the location annotation system and method is shown in FIG. 2. As shown in process action 202, the location history and a document set are input into the system. The system then begins to process the first document in the document set (process action 204). It finds the record in the location history that has a time stamp nearest to the time of interest related to the document (process action 206), and associates the document's time of interest with the paired location from the record in the location history associated with the time nearest to the time of interest (process action 208). This process is then repeated until all documents in the document set have been processed (process actions 210, 212).

There are many other variations to the above, each of which has its advantages.

2.5.3 Nearest Earlier Neighbor Embodiment: The Nearest Earlier Neighbor embodiment functions in a manner similar to the Nearest Neighbor embodiment discussed above. However, this embodiment differs in that it is constrained further to return the location associated with a time that is before or equal to the time-stamp of the document. In the example above, the photograph would then be associated with the photographer's GPS coordinates at 1 pm, instead of 2 pm, Dec. 27, 2001.

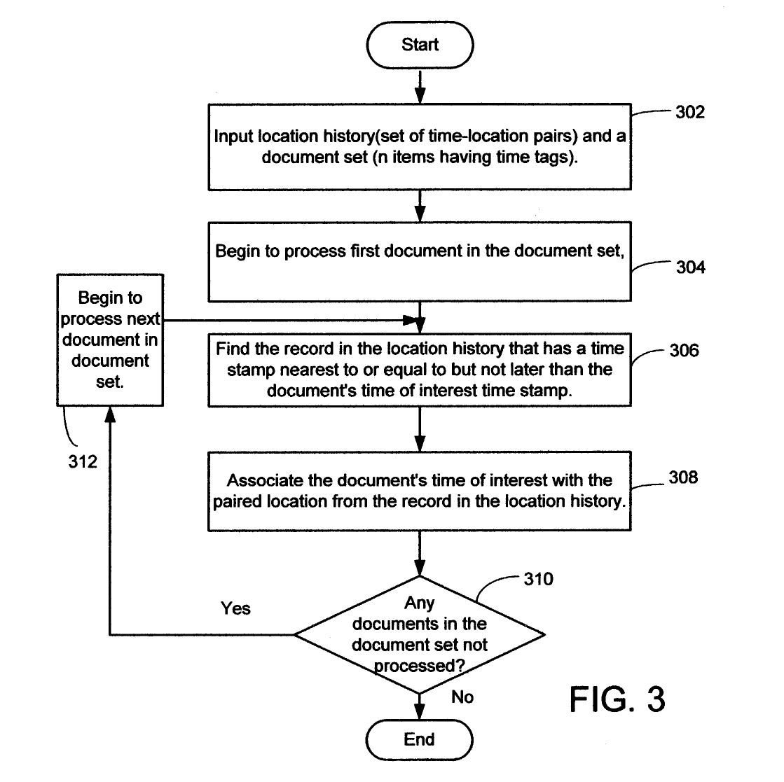

A general flowchart of the Nearest Earlier Neighbor embodiment is shown in FIG. 3. Again, similar to the process shown in FIG. 2, as shown in process action 302, the location history and a document set are input into the system. The system then begins to process the first document in the document set (process action 304). It finds the record in the location history that has a time stamp nearest to or equal to, but not later than, the time of interest related to the document (process action 306), and associates the document's time of interest with the paired location from the record in the location history associated with the time nearest to or equal to, but not later than, the time of interest (process action 308). This process is then repeated until all documents in the document set have been processed (process actions 310, 312). It should be noted that this embodiment could also be implemented by selecting a record with the time nearest to, and not equal to, but not later than, the time of interest.

2.5.4 Nearest Later Neighbor Embodiment: The Nearest Later Neighbor embodiment also operates in a manner similar to the Nearest Neighbor embodiment except that the constraint is for the location associated with a time that is equal to or after the time-stamp of interest of the document. In the example above, the returned location would be the same, because 2 pm occurs after 1:59 pm.

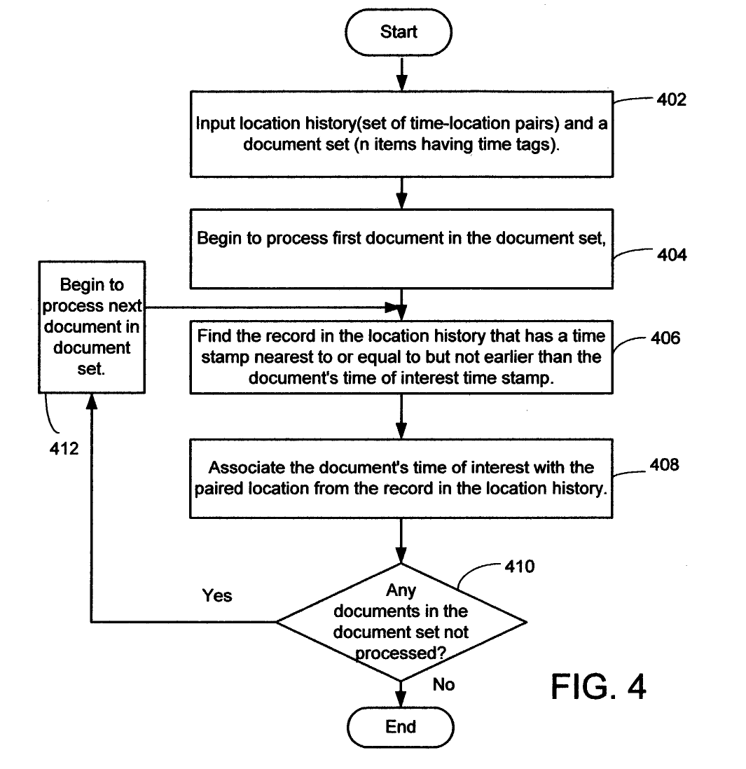

A general flowchart of the Nearest Later Neighbor embodiment is shown in FIG. 4. Again, as shown in process action 402, the location history and a document set are input into the system. The system then begins to process the first document in the document set (process action 404). It finds the record in the location history that has a time stamp nearest to or equal to, but not earlier than, the time of interest related to the document (process action 406), and associates the document's time of interest with the paired location from the record in the location history associated with the time nearest to or equal to, but not earlier than, the time of interest (process action 408). This process is then repeated until all documents in the document set have been processed (process actions 410, 412). It should be noted that this embodiment could also be implemented by selecting a record with the time nearest to, and not equal to, but not earlier than, the time of interest.

All of the Nearest Neighbor algorithms have the advantage of simplicity and speed, as they could be, though not restricted to be, implemented as a binary search that takes O(log n) time, where n is the size of the location history.

2.5.5 Interpolated Location Embodiment: In the Interpolated Location Embodiment of the location annotation system and method, the system interpolates location if the exact desired time of an event is not available. There are a number of ways to interpolate data, if data for the exact time desired is missing in the location history. Methods of interpolation are all well-known in the engineering literature. One of the simplest is linear interpolation. In the example above, since data exists only for 1 pm and 2 pm, but the desired location is for 1:59 pm, the two-dimensional coordinate x(t_{1:59})=(1−α)×(t_{1:00})+α×(t_{2:00}), where α=(t_{1:59}−t_{1:00})/(t_{2:00}−t_{1:00}) is computed. Other interpolation schemes include, but are not restricted to, the use of splines or other curves.

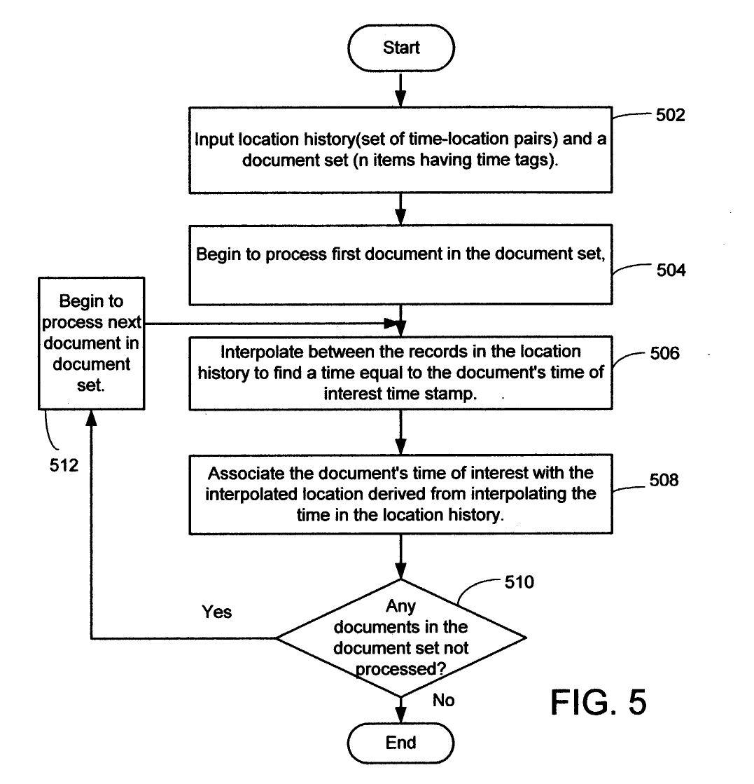

A general flowchart of the Interpolated Location embodiment is shown in FIG. 5. Again, as shown in process action 502, the location history and a document set are input into the system. The system then begins to process the first document in the document set (process action 504). It interpolates between the records in the location history to obtain a time equal to the documents time of interest (process action 506), and associates the document's time of interest with the interpolated location derived from interpolating the time in the location history (process action 508). This process is then repeated until all documents in the document set have been processed (process actions 510, 512). Interpolation algorithms are also simple to implement and almost as efficient as the Nearest Neighbor algorithms. They can also be implemented in O(log n) time, but potentially give the benefit of additional accuracy, especially when the location history is densely populated.

2.5.6 Model-Interpolated Location Embodiment: In the Model Interpolated Location embodiment of the invention, one or more models are employed to interpolate location at a given time. Instead of blindly interpolating the location among the temporal neighbors of the data as above, the Model-Interpolated location embodiment uses “semantic” or generative or other models of the data. For example, GPS units do not work indoors and can take a few minutes to register their position once outdoors. As a result, GPS-based location histories of a person carrying a GPS device on their person often result in long stretches of time without location data, and, upon going outdoors, the person may travel a considerable distance before the GPS device registers its location. Using linear interpolation as described above is inappropriate for location-associating a time in the middle of the person's stay indoors, since the person is likely to have been much closer to the last known GPS location, than the point where the GPS device began tracking later. A model of the location-history collecting device accurately accounts for these asymmetries in the data and location-associates target documents correctly. Similarly, complex probabilistic models of an entity's location can be built based on their location histories, and these can be used to fill-in gaps in an existing location history. These models may be generative models, rule-based models, probabilistic/statistical models, calendar-based models, frequency-based models or any other model that encodes the location history and location patterns of the modeled entity.

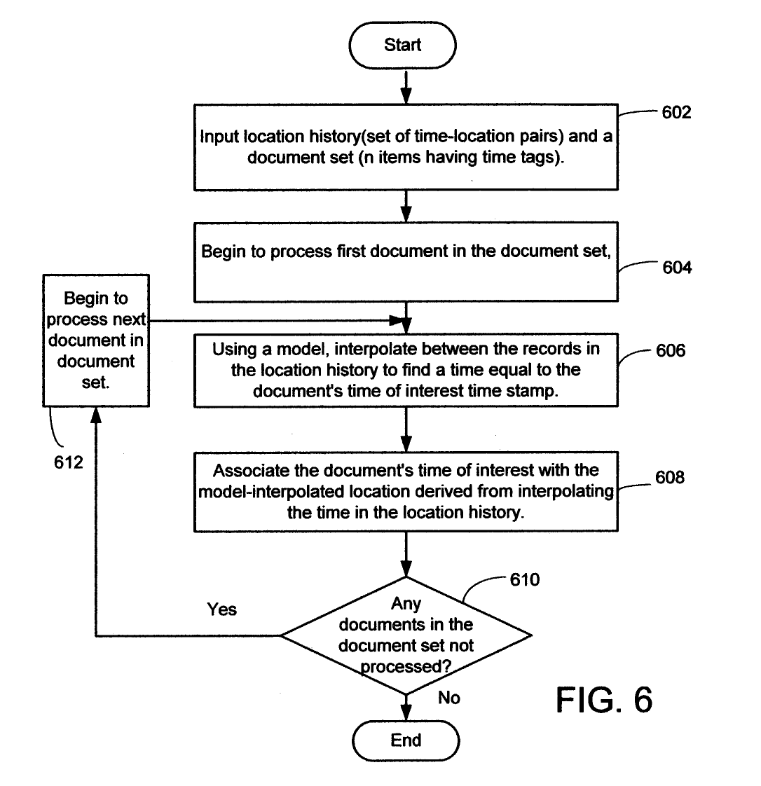

A general flowchart of the Model-Interpolated Location embodiment is shown in FIG. 6. Again, as shown in process action 602, the location history and a document set are input into the system. The system then begins to process the first document in the document set (process action 604). It interpolates between the records in the location history to obtain a time equal to the documents time of interest (process action 606) using a model, and associates the document's time of interest with the model-interpolated location derived from interpolating the time in the location history (process action 608). This process is then repeated until all documents in the document set have been processed (process actions 610, 612).

Model-interpolation requires considerable additional processing beyond that required for the previous methods. The location history itself may require processing offline as preparation for location annotation. The benefits are that significant gaps in the location history may be handled gracefully, effectively by using repetitive patterns in the location history to infer the missing parts of the history.

2.5.7 Extrapolated Location Embodiment: The Extrapolated Location embodiment uses extrapolation to specify a location that is out of the range of a location history. It is possible, by using extrapolation instead of interpolation, to generate location associations for instances that are outside the range of a location history. These can apply to moments in the past prior to when the first location-history datum is available; or, they can apply to the future. These techniques are straightforward extensions of the interpolation methods described above.

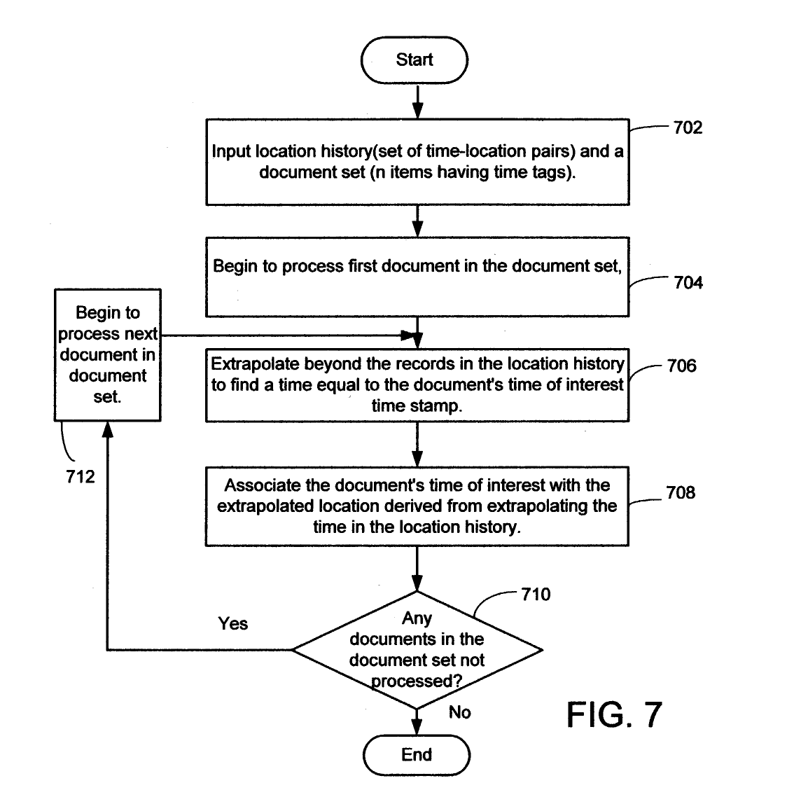

A general flowchart of the Extrapolated Location embodiment is shown in FIG. 7. Again, as shown in process action 702, the location history and a document set are input into the system. The system then begins to process the first document in the document set (process action 704). It extrapolates beyond the records in the location history to obtain a time equal to the documents time of interest (process action 706), and associates the document's time of interest with the extrapolated location derived from extrapolating the time in the location history (process action 708). This process is then repeated until all documents in the document set have been processed (process actions 710, 712).

Extrapolation can occur effectively in O(1) time, and otherwise has the same benefits as Interpolation.

2.5.8 Fused Location Embodiment: If multiple location histories are available, standard techniques for fusing data can be used in combination with any of the techniques above to result in more accurate location associations. Data fusing techniques are well-described in the signal processing, robotics, and machine learning literature, and can be based on, but are not limited to, probabilistic fusion, explicit procedural fusion through if-then statements, fusion by voting, averaging, weighted averaging, median computation, and so forth.

Depending on the complexity of the fusing algorithm and the underlying sources of location histories, fusion has the potential for providing very accurate location information during location annotation.

2.6 Additional Related Processing.

The core location-association module can be enhanced by a variety of augmentations. For example, a variety of time-stamp adjustments can improve the accuracy of location association.

2.6.1 Time-Stamp Offset Synchronization: In some embodiments employing multiple data sources, time stamps that could be in any format (e.g., year/month/date, time from a given reference time) are offset to synchronize the time stamps from the various sources to a common reference time. This is done by keeping track of the offsets between time-stamping devices such as cameras, PDAs, laptops, GPS, cellular phones, and so forth, with a single computer's clock. The time-stamps produced by these devices can now be offset accordingly, particularly with respect to location histories and target documents, so that all relevant time-stamps are synchronized to the same clock. Any two devices (and therefore, time stamps generated by those devices) can be synchronized as long as one can connect a path of pair wise edges between devices, where an edge exists whenever two devices have been connected to each other in the last T units of time, where T depends on the accuracy of the individual clocks.

2.6.2 Time-Stamp Synchronization by Alignment: If there is a priori information that certain target documents tend to be created at certain times or certain locations, this information can be used to synchronize time stamps in the absence of offset synchronization. For example, if it is known that a photographer promptly begins work at 9 am but time stamps on his photographs show many photos taken as early as 8:30 am, a correction may be applied that offsets the time stamps of all photos taken by that camera by 30 minutes. More sophisticated means to accomplish this would use statistical means to determine the optimal offset.

Additional information about the location associations themselves may be computed and used to affect the location association output.

2.6.3 Location-Association Metadata: The location association itself may come with metadata about the circumstances under which the location-association was made: (1) the source of the location history, (2) the reliability of the location history, (3) the nearness in time of available location history, (4) the entity for which the location history is available, (5) the circumstances under which location history was taken, (6) knowledge about the location association algorithm or location history models used, etc. This information may be used by applications downstream to estimate the accuracy and precision of the location annotation.

2.6.4 Confidence Values: Location associations may themselves be stamped with confidence values based on information such as (1) the source of the location history, (2) the reliability of the location history, (3) the nearness in time of available location history, (4) the entity for which the location history is available, (5) the circumstances under which location history was taken, (6) knowledge about the location association algorithm or location history models used, and so forth. This information may be used by applications downstream to estimate the accuracy and precision of the location annotation.

2.6.5 Precision Estimates: Location associations may come with precision estimates, for example, in the form of a covariance of the expected error associated with a location-association estimate. Other precision estimates may take the form of quantized precision values (e.g., “low,” “intermediate,” “high”), a bounding box, a histogram or probability distribution function of the estimated location association, and so on. This information may be used by applications downstream to,estimate the accuracy and precision of the location annotation.

2.6.6 Location-Association Invalidation Based on Confidence Scores: If the confidence value for a location association is too low, the location-association module may output “undefined” or otherwise signal that no valid location association can be made.

The foregoing description of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

Wherefore, what is claimed is:

1. A process for associating location information to an electronic document, comprising the following process actions:
inputting a record of an entity's time-stamped location history;
inputting one or more target documents which are time-stamped, with the time-stamp being meaningfully related to at least one event of interest in the lifetime of the target document; and
associating said time of said event of interest of said one or more target documents with said entity's location history to obtain the location where the event of interest occurred.

2. The process of claim 1 further comprising the following process action:
storing said obtained location for later access.

3. The process of claim 2 wherein storing said obtained location comprises one of:
storing said obtained location in the target document as metadata, and storing said obtained location in a database and associated with the target document.

4. The process of claim 1 further comprising the following process action:
computing the location information each time location information about the target document is requested.

5. The process of claim 4 further comprising the process action of:
displaying the location information.

6. The process of claim 5 wherein the process action of displaying the location information comprises displaying the location information on a map.

7. The process of claim 1 wherein the process action of associating said event of interest of said one or more target documents with said entity's location history to obtain the location where the event occurred comprises:
determining the time in the location history with a time closest to the time of the event of interest; and
associating said location corresponding to the time in location history with a time closest to the time of the event of interest.

8. The process of claim 1 wherein the process action of associating said event of interest of said one or more target documents with said entity's location history to obtain the location where the event occurred comprises:
determining the time in the location history with a time closest to the time of the event of interest but no later than the event of interest; and
associating said location corresponding to the time in location history with a time closest but no later than the time of the event of interest.

9. The process of claim 1 wherein the process action of associating said event of interest of said one or more target documents with said entity's location history to obtain the location where the event occurred comprises:
determining the time in the location history with a time closest to the time of the event of interest but no earlier than the event of interest; and
associating said location corresponding to the time in location history with a time closest but no earlier than the time of the event of interest.

10. The process of claim 1 wherein the process action of associating said event of interest of said one or more target documents with said entity's location history to obtain the location where the event occurred comprises the process actions of:
interpolating a location corresponding to a time in the location history corresponding to a time equal to or within a prescribed range of the time of the event of interest; and
associating said location corresponding to said interpolated the time in said location history with a time equal to or within a prescribed range of the time of the event of interest.

11. The process action of claim 10 the process action of interpolating a location comprises using one of the following interpolation techniques:
linear interpolation;
spline-based interpolation;
curve fitting;
and regression.

12. The process of claim 1 wherein the process action of associating said event of interest of said one or more target documents with said entity's location history to obtain the location where the event occurred comprises the process actions of:
extrapolating a location corresponding to a time in the location history corresponding to a time equal to or within a prescribed range of the time of the event of interest; and
associating said location corresponding to said extrapolated the time in said location history with a time equal to or within a prescribed range of the time of the event of interest.

13. The process action of claim 12 the process action of extrapolating a location comprises using one of the following interpolation techniques:
linear extrapolation;
spline-based extrapolation;
curve fitting and regression, followed by extrapolation; and
model-based extrapolation.

14. The process of claim 1 further comprising the following process, actions:
inputting at least one additional record of another entity's time-stamped location history;
determining the record of the entity's whose time-stamped location history is closest to said time of interest; and
associating said time of event of interest of said one or more target documents with said entity's location history closest to said time of interest to obtain the location where the event occurred.

15. The process of claim 1 further comprising the following process actions:
inputting at least one additional record of at least one additional entity's time-stamped location history;
determining the time offset between each record of each entity's time-stamped location history compared to a reference time; and
ordering each record relative to said reference time using said time offset.

16. The process of claim 1 wherein said location history further comprises at least one of:
source of the location history;
reliability of the source of location history;
nearness in time of available location history;
entity with which location history was associated;
circumstances under which location history was taken; and
the location-association algorithm used with its relevant parameters

17. The process of claim 15 further comprising the process action of analyzing both the location history and the at least one target document to determine the optimal offset in time.

18. The process of claim 1 further comprising the process action of:
determining a constraint as to how far the time-stamp in said location history can be from the time of event of interest to determine a valid location; and
indicating that the obtained location is invalid if the location history does not contain a record within the constraint.

19. A system for associating location information with a document, the system comprising:
a general purpose computing device; and
a computer program comprising program modules executable by the computing device, wherein the computing device is directed by the program modules of the computer program to,
input a document set, said document set having one or more documents with time tags, and a record of at least one entity's time-stamped location history, said location history including a set of time-location pairs and being related to an event occurring relative to a document in said document set, and;
associate a time of interest of said one or more documents in said document set with said at least one entity's location history to obtain the location where at least one document event occurred.

20. The system of claim 19 wherein the module to associate said time of interest of said one or more target documents with said entity's location history to obtain the location where at least one event occurred comprises sub-modules to:
interpolate a location corresponding to a time in the location history equal to or within a prescribed range of the time of interest; and
associate said location corresponding to said interpolated time in said location history with a time equal to or within a prescribed range of the time of the event of interest.

21. The system of claim 20 wherein the sub-module to interpolate location uses at least one of the following:
linear interpolation;
spline-based interpolation; and
curve fitting.

22. The system of claim 20 wherein the sub-module to interpolate location uses a model to perform said interpolation.

23. The system of claim 22 wherein said model employs at least one of:
a generative model,
a rule-based model,
a probabilistic model,
a statistical model,
a calendar-based model,
a frequency-based model, or
any model that encodes the location history and location patterns of the modeled entity.

24. The system of claim 19 wherein a document is any electronic entity regardless of its permanence or the means by which it stored.

25. The system of claim 24 wherein said electronic entity is one of:
a file;
a portion of a file;
a database entry; or
a temporary data structure which may never be saved to disk.

26. The system of claim 19 wherein said document is one of:
a photograph;
an image file;
a text document;
a presentation;
a music file; or
a video.

27. The system of claim 26 wherein said location history is one of:
a list of global positioning system coordinates, together with time stamps;
a list or database of place names, together with time stamps or intervals;
a portable computing device wireless hub location, together with time stamps;
a location history obtained by a cellular telephone's triangulated position based on the strength of the signal from nearby cell transmitters, together with corresponding time stamps;
a collection of time stamped documents which are themselves location stamped; and
a combination of one or more of the above.

28. A computer-readable medium having computer-executable instructions for correlating location information with a document, said computer executable instructions comprising modules for:
inputting a record of an entity's time-stamped location history;
inputting one or more documents which are time-stamped, with each time-stamp being meaningfully related to an event of interest in the lifetime of the document; and
associating said time of said event of interest of said one or more documents with said entity's location history to obtain the location where the event of interest occurred.

29. The computer-readable medium of claim 28 wherein a confidence value is calculated with respect to said entity's location history and wherein said confidence value is used to estimate the accuracy of the location where the event of interest occurred.

30. The computer-readable medium of claim 29 wherein said confidence value is used to determine the validity of the location where the event occurred.

31. The computer-readable medium of claim 28 wherein a precision estimate is calculated with respect to said entity's location history and wherein said precision estimate is used to estimate the precision of the location where the event of interest occurred.

32. The computer-readable medium of claim 29 wherein said confidence value is used to determine the validity of the location where the event occurred.
